(19) United States
(12) Patent Application Publication
(10) Pub. No.: US 2023/0252767 A1
(43) Pub. Date: Aug. 10, 2023

(54) TECHNOLOGY TO CONDUCT POWER-EFFICIENT MACHINE LEARNING FOR IMAGES AND VIDEO

(71) Applicant: Intel Corporation, Santa Clara, CA (US)

(72) Inventor: Vasily Aristarkhov, Magdeburg (DE)

(21) Appl. No.: 18/303,007

(22) Filed: Apr. 19, 2023

(51) Int. Cl. G06V 10/774; G06V 10/776

(52) U.S. Cl. CPC G06V 10/774; G06V 10/776

(57) ABSTRACT

Systems, apparatuses and methods may provide for technology that filters, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline, identifies, during an inference phase of the ML pipeline, second irrelevant images in a second compressed bitstream, and filters, during the inference phase of the ML pipeline, the second irrelevant images from the second compressed bitstream prior to the second compressed bitstream being transmitted to the decompression stage of the ML pipeline.

### TECHNICAL FIELD

Embodiments generally relate to machine learning. More particularly, embodiments relate to technology to conduct power-efficient machine learning for images and video.

### BACKGROUND OF THE DISCLOSURE

Compressed media is in widespread use throughout society. For artificial intelligence (AI) analysis to be conducted on the underlying content, decoding of the compressed media is typically conducted. Traditional image and/or video decoding operations, however, are sequential and tend to be the slowest operations in the machine learning pipeline. Additionally, the performance gap between decoding media compute power and AI workload processing may translate into a significant amount of wasted power usage in data centers.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a machine learning (ML) pipeline according to an embodiment;

FIG. 2 is a block diagram of an example of a distributed ML pipeline according to an embodiment;

FIG. 3 is a comparative illustration of an example of a conventional decompression scheme and an enhanced decompression scheme according to an embodiment;

FIG. 4 is a plot of an example of a recall-precision operating point according to an embodiment;

FIG. 5 is a flowchart of an example of a method of operating a performance-enhanced computing system according to an embodiment;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DETAILED DESCRIPTION

Technology described herein uses an agent integrated into a machine learning (ML) pipeline to operate directly on compressed bitstreams/data to remove content that would otherwise result in unnecessary decoding. As a result, only a few images are decompressed and analyzed by the ML model of the pipeline. The technology therefore significantly enhances performance through reduced power consumption.

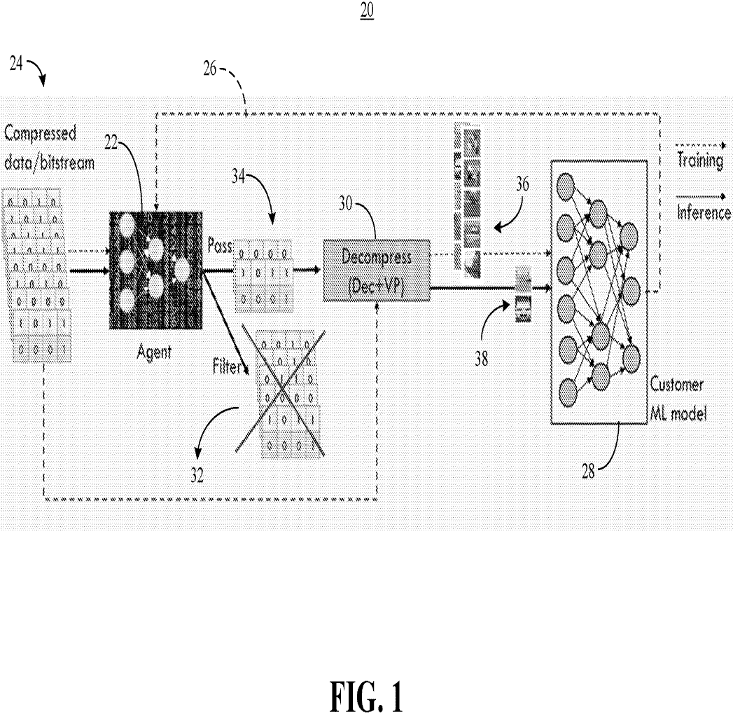

Turning now to FIG. 1, an ML pipeline 20 is operated in a training phase/mode and an inference phase/mode. During the training phase, an ML software (SW) agent 22 receives a compressed bitstream 24 (e.g., training data including still images, video frames, etc.) and uses feedback 26 (e.g., reinforcement learning feedback) from a ML model 28 of the ML pipeline 20 to effectively remove decoding and preprocessing operations for the biggest portion of the dataset. More particularly, the SW agent 22 represents a neuro-decoder that is trained to make a simple decision: pass or not pass an image for the full decoding performed by a decompression stage 30 and analysis performed by the ML model 28.

In the illustrated example, the SW agent 22 filters out irrelevant images 32 from compressed bitstream 24 and passes relevant images 34 in the compressed bitstream 24 onto the decompression stage 30. Thus, the irrelevant images 32 bypass the decoding and pre-processing operations of the decompression stage 30, which would otherwise be costly in terms of time and power consumption. In an embodiment, relevance is determined with respect to the ML model 28. Thus, the relevant images 34 are more likely to be targeted by the ML model 28 than the irrelevant images 32.

In the illustrated example, a training output 36 of the decompression stage 30 includes both the decoded relevant images 34 and the compressed bitstream 24, wherein the ML model 28 iteratively generates the feedback 26 (e.g., back loop connection communicating quantified error) for the SW agent 22 to indicate whether the decisions of the SW agent 22 were correct. The training process has a relatively small overhead because the computational complexity of the SW agent 22 is low. Once the training phase has reached a target level of accuracy, the ML pipeline 20 transitions from the training phase to the inference phase.

During the inference phase, the SW agent 22 receives the compressed bitstream 24 (e.g., inference data including still images, video frames, etc.) and determines whether to pass each image for the full decoding performed by the decompression stage 30. In the illustrated example, an inference output 38 of the decompression stage 30 includes decoded relevant images, which is a small subset of the overall content of the compressed bitstream 24. As will be discussed in greater detail, the accuracy/performance tradeoffs of the SW agent 22 can be managed on-the-fly during the inference phase. The SW agent 22 is significantly faster than any modern hardware (HW) or central processing unit (CPU) decoders. Additionally, the performance ratio between the SW agent 22 and decoders can depend on many factors. In one example, the SW agent 22 could be relatively complex, with the ability to filter-out more redundant images. In other examples, the low complexity of the SW agent 22 is explained by the decision-making process in which the SW agent 22 plays a filter role and does not replace or modify the more complex and accurate ML model 28, but rather cooperates with the ML model 28. Thus, the ML model 28 acts as a supervisor to the SW agent 22.

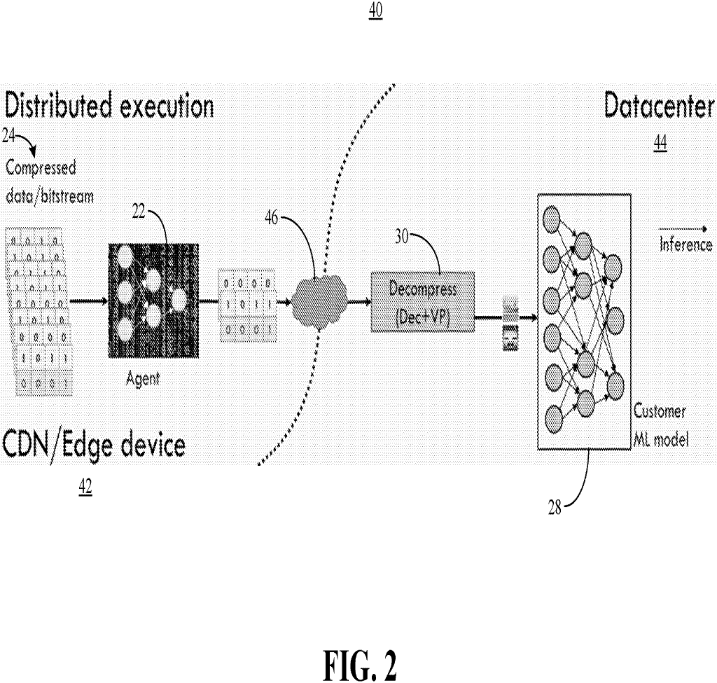

FIG. 2 shows a distributed ML pipeline 40 in which the compressed bitstream 24 is generated on an edge device 42 or content delivery network (CDN) and the decompression stage 30 and the ML model 28 reside on a remote data center 44. In such a case, the SW agent 22 may be deployed on the edge device 42 or CDN to save bandwidth on a network 46. More particularly, the illustrated SW agent 22 filters the irrelevant images from the compressed bitstream 24 prior to the relevant images in the compressed bitstream 24 being transmitted to the network 46 (e.g., via a network controller, not shown).

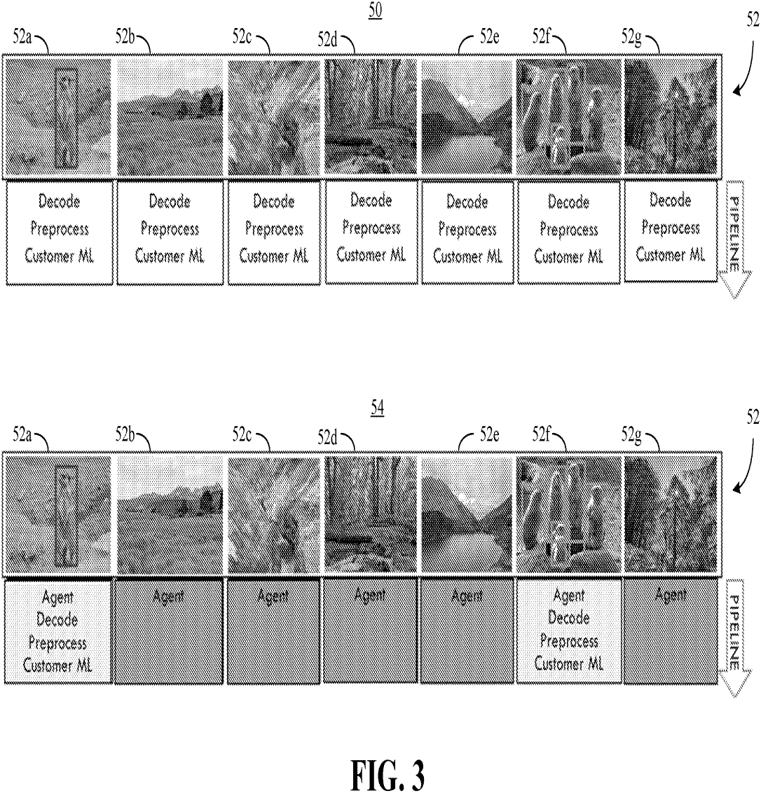

FIG. 3 shows a conventional decompression scheme 50 in which an AI application is tasked with identifying all prairie dogs in an image data set 52 (52a-52g). In the illustrated example, the conventional decompression scheme 50 decodes and pre-processes all images in the image data set 52, regardless of whether the images may contain animals that might be prairie dogs. Such an approach can be wasteful of decompression and/or network resources, which may in turn have a negative impact on performance, power consumption and/or network bandwidth, particularly when only a small percentage of the images contain any animals. By contrast, an enhanced decompression scheme 54 uses an agent (e.g., neuro-decoder) to automatically determine that images 52b-52e and 52g are potentially irrelevant and therefore exclude images 52b-52e and 52g from the decoding and/or pre-processing operations of the decompression stage of the ML pipeline.

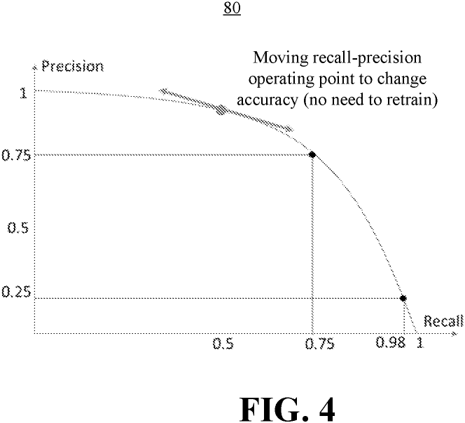

FIG. 4 shows a plot 80 that may be used to conduct accuracy adjustments in the inference phase. More particularly, managing the precision-recall operating point of the plot 80 enables the accuracy of the inference phase to be set without repeating the training phase. For example, moving the operating point to the right increases the validity of results while sacrificing the completeness of results. By contrast, moving the operating point to the left decreases the validity of results while improving the completeness of results. For example, if the data set contains 100 images/frames, with ten of the images being target images and ninety of the images being non-target images, shifting the operating point to the right would minimize the probability of missing the target images, while passing more non-target images. Thus, such an adjustment might pass nine target images (e.g., one target image is filtered out) and fifty non-target images (e.g., forty non-target images filtered out). By contrast, shifting the operating point to left might pass seven target images (e.g., three target images filtered out) and thirty non-target images (e.g., sixty non-target images filtered out).

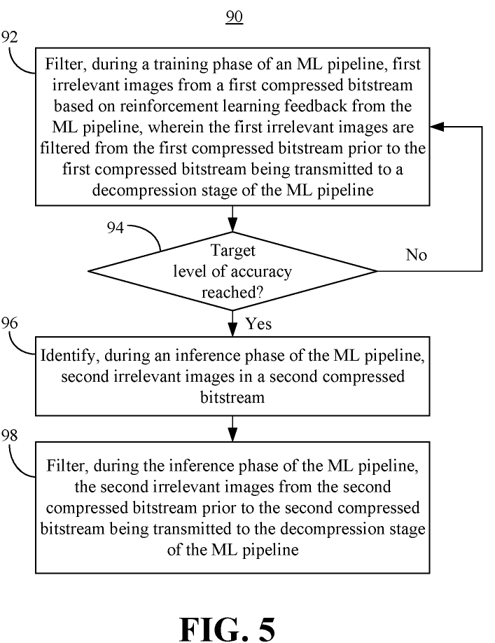

FIG. 5 shows a method 90 of operating a performance-enhanced computing system. The method 90 may generally be implemented in an agent such as, for example, the software agent 22 (FIGS. 1-2) and/or the agent 60 (FIG. 4), already discussed. More particularly, the method 90 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 90 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 92 filters, during a training phase of an ML pipeline, first irrelevant images from a first compressed bitstream (e.g., training image data) based on reinforcement learning feedback from the ML pipeline, wherein the first irrelevant images are filtered from the first compressed bitstream prior to the first compressed bitstream being transmitted to a decompression stage of the ML pipeline. A determination may be made at block 94 as to whether the training phase has reached a target level of accuracy (e.g., quantified error). If not, the method 90 returns to block 92. Otherwise, block 96 identifies (e.g., in the pixel domain), during an inference phase of the ML pipeline, second irrelevant images in a second compressed bitstream (e.g., inference image data). Block 98 filters (e.g., in the bitstream domain), during the inference phase of the ML pipeline, the second irrelevant images from the second compressed bitstream prior to the second compressed bitstream being transmitted to the decompression stage of the ML pipeline.

In one example, block 96 also conducts an accuracy adjustment of the inference phase via a recall-precision operating point, wherein the accuracy adjustment bypasses a repeat of the training phase. Moreover, block 96 may bypass a modification (e.g., using spars and/or prune techniques) of an ML model in the ML pipeline. In an embodiment, block 98 bypasses one or more decoding operations and/or one or more pre-processing operations of the decompression stage with respect to the second irrelevant images. Additionally, block 98 may filter the second irrelevant images from the second compressed bitstream prior to the second compressed bitstream being transmitted to a network controller (e.g., in a distributed ML pipeline).

The method 90 therefore enhances performance at least to the extent that filtering the second irrelevant images from the second compressed bitstream prior to relevant images in the second compressed bitstream being transmitted to the decompression stage reduces power consumption associated with the decoding and/or pre-processing operations of the decompression stage. The method 90 also enhances performance by increasing network bandwidth (e.g., in a distributed ML pipeline).

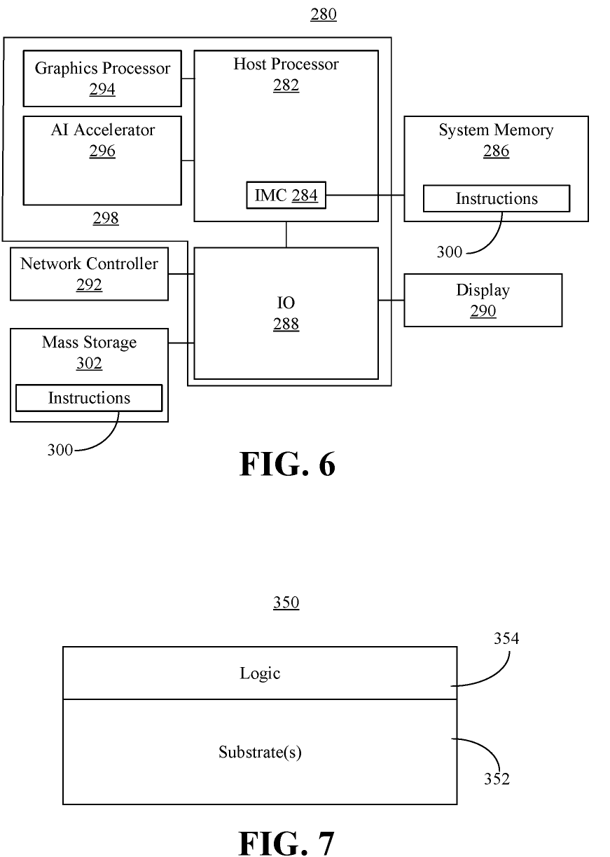

Turning now to FIG. 6, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 executes instructions 300 retrieved from the system memory 286 and/or the mass storage 302 to perform one or more aspects of the method 90 (FIG. 5), already discussed. Thus, the execution of the instructions 300 by the AI accelerator 296 causes the AI accelerator 296 to filter, during a training phase of an ML pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline. Execution of the instructions 300 by the AI accelerator 296 also causes the AI accelerator 296 to identify, during an inference phase of the ML pipeline, second irrelevant images in a second compressed bitstream and filter, during the inference phase of the ML pipeline, the second irrelevant images from the second compressed bitstream prior to the second compressed bitstream being transmitted to the decompression stage of the ML pipeline.

The computing system 280 is therefore considered performance-enhanced at least to the extent that filtering the second irrelevant images from the second compressed bitstream prior to relevant images in the second compressed bitstream being transmitted to the decompression stage reduces power consumption associated with the decoding and/or pre-processing operations of the decompression stage. The computing system 280 is also considered performance-enhanced due to increased network bandwidth (e.g., in a distributed ML pipeline).

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 90 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

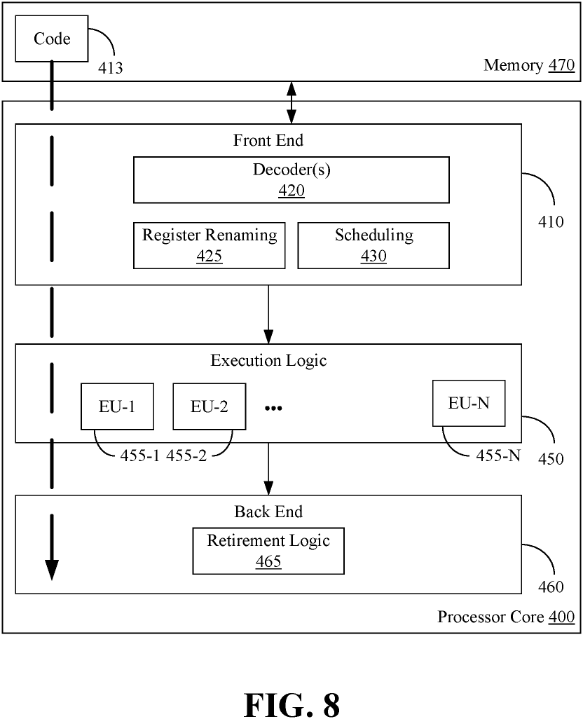

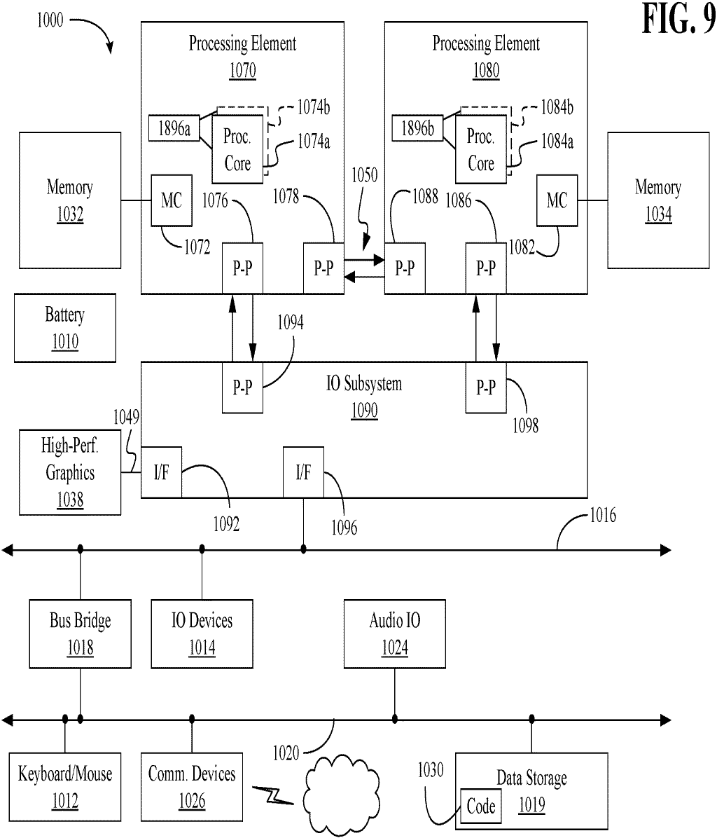

FIG. 8 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 8, a processing element may alternatively include more than one of the processor core 400 illustrated in FIG. 8. The processor core 400 may be a single-threaded core or, for at least one embodiment, the processor core 400 may be multithreaded in that it may include more than one hardware thread context (or “logical processor”) per core.

FIG. 8 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 90 (FIG. 5), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 8, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC’s 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 90 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### Additional Notes and Examples

Example 1 includes a performance-enhanced computing system comprising a network controller, a processor coupled to the network controller, and a memory coupled to the processor, the memory including a set of instructions, which when executed by the processor, cause the processor to filter, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline, identify, during an inference phase of the ML pipeline, second irrelevant images in a second compressed bitstream, and filter, during the inference phase of the ML pipeline, the second irrelevant images from the second compressed bitstream prior to the second compressed bitstream being transmitted to the decompression stage of the ML pipeline.

Example 2 includes the computing system of Example 1, wherein the instructions, when executed, further cause the processor to bypass one or more decoding operations of the decompression stage with respect to the second irrelevant images.

Example 3 includes the computing system of Example 1, wherein the instructions, when executed, further cause the processor to bypass one or more pre-processing operations of the decompression stage with respect to the second irrelevant images.

Example 4 includes the computing system of Example 1, wherein the instructions, when executed, further cause the processor to transition the ML pipeline from the training phase to the inference phase in response to a detection that the training phase has reached a target level of accuracy.

Example 5 includes the computing system of Example 1, wherein the second irrelevant images are filtered from the second compressed bitstream prior to the second compressed bitstream being transmitted to the network controller.

Example 6 includes the computing system of Example 1, wherein the instructions, when executed, further cause the processor to conduct an accuracy adjustment of the inference phase via a recall-precision operating point, wherein the accuracy adjustment bypasses a repeat of the training phase.

Example 7 includes the computing system of any one of Examples 1 to 6, wherein the instructions, when executed, further cause the computing system to bypass a modification of an ML model in the ML pipeline.

Example 8 includes at least one computer readable storage medium comprising a set of instructions, which when executed by a computing system, cause the computing system to filter, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline, identify, during an inference phase of the ML pipeline, second irrelevant images in a second compressed bitstream, and filter, during the inference phase of the ML pipeline, the second irrelevant images from the second compressed bitstream prior to the second compressed bitstream being transmitted to the decompression stage of the ML pipeline.

Example 9 includes the at least one computer readable storage medium of Example 8, wherein the instructions, when executed, further cause the computing system to bypass one or more decoding operations of the decompression stage with respect to the second irrelevant images.

Example 10 includes the at least one computer readable storage medium of Example 8, wherein the instructions, when executed, further cause the computing system to bypass one or more pre-processing operations of the decompression stage with respect to the second irrelevant images.

Example 11 includes the at least one computer readable storage medium of Example 8, wherein the instructions, when executed, further cause the computing system to transition the ML pipeline from the training phase to the inference phase in response to a detection that the training phase has reached a target level of accuracy.

Example 12 includes the at least one computer readable storage medium of Example 8, wherein the second irrelevant images are filtered from the second compressed bitstream prior to the second compressed bitstream being transmitted to a network controller.

Example 13 includes the at least one computer readable storage medium of Example 8, wherein the instructions, when executed, further cause the computing system to conduct an accuracy adjustment of the inference phase via a recall-precision operating point, wherein the accuracy adjustment bypasses a repeat of the training phase.

Example 14 includes the at least one computer readable storage medium of any one of Examples 8 to 13, wherein the instructions, when executed, further cause the computing system to bypass a modification of an ML model in the ML pipeline.

Example 15 includes a method of operating a performance-enhanced computing system, the method comprising filtering, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline, identifying, during an inference phase of the ML pipeline, second irrelevant images in a second compressed bitstream, and filtering, during the inference phase of the ML pipeline, the second irrelevant images from the second compressed bitstream prior to the second compressed bitstream being transmitted to the decompression stage of the ML pipeline.

Example 16 includes the method of Example 15, further comprising bypassing one or more decoding operations of the decompression stage with respect to the second irrelevant images, and bypassing one or more pre-processing operations of the decompression stage with respect to the second irrelevant images.

Example 17 includes the method of Example 15, further including transitioning the ML pipeline from the training phase to the inference phase in response to a detection that the training phase has reached a target level of accuracy.

Example 18 includes the method of Example 15, wherein the second irrelevant images are filtered from the second compressed bitstream prior to the second compressed bitstream being transmitted to a network controller.

Example 19 includes the method of Example 15, further comprising conducting an accuracy adjustment of the inference phase via a recall-precision operating point, wherein the accuracy adjustment bypasses a repeat of the training phase.

Example 20 includes the method of any one of Examples 15 to 19, further comprising bypassing a modification of an ML model in the ML pipeline.

Example 21 includes a method of operating a performance-enhanced computing system, the method comprising identifying, during an inference phase of a machine learning (ML) pipeline, irrelevant images in a compressed bitstream and filtering, during the inference phase of the ML pipeline, the irrelevant images from the compressed bitstream prior to the compressed bitstream being transmitted to a decompression stage of the ML pipeline.

Example 22 includes an apparatus comprising means for performing the method of any one of Examples 15-21.

Technology described herein therefore keeps AI and/or ML models unchanged, making relatively simple pre-analysis and filtering-out less probable candidates. The technology described herein leverages any known optimization techniques to achieve cumulative performance and/or power-saving impacts. The technology does not require access to customer ML models and datasets. Rather, the technology is trained in the customer environment/ecosystem and delivered as a black box. The technology described herein also helps to close the performance gap between decoding media compute power and AI workload processing. Indeed, the technology described herein may even lead to AI benchmarks that use images with resolutions that are on par with the resolutions of modern day cameras (e.g., rather than using relatively low resolution images).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
filter, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline,
identify, during an inference phase of the ML pipeline, second irrelevant images in a second compressed bitstream, and
filter, during the inference phase of the ML pipeline, the second irrelevant images from the second compressed bitstream prior to the second compressed bitstream being transmitted to the decompression stage of the ML pipeline.

2. The computing system of claim 1, wherein the instructions, when executed, further cause the processor to bypass one or more decoding operations of the decompression stage with respect to the second irrelevant images.

3. The computing system of claim 1, wherein the instructions, when executed, further cause the processor to bypass one or more pre-processing operations of the decompression stage with respect to the second irrelevant images.

4. The computing system of claim 1, wherein the instructions, when executed, further cause the processor to transition the ML pipeline from the training phase to the inference phase in response to a detection that the training phase has reached a target level of accuracy.

5. The computing system of claim 1, wherein the second irrelevant images are filtered from the second compressed bitstream prior to the second compressed bitstream being transmitted to the network controller.

6. The computing system of claim 1, wherein the instructions, when executed, further cause the processor to conduct an accuracy adjustment of the inference phase via a recall-precision operating point, wherein the accuracy adjustment bypasses a repeat of the training phase.

7. The computing system of claim 1, wherein the instructions, when executed, further cause the computing system to bypass a modification of an ML model in the ML pipeline.

8. At least one computer readable storage medium comprising a set of instructions, which when executed by a computing system, cause the computing system to:
filter, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline;
identify, during an inference phase of the ML pipeline, second irrelevant images in a second compressed bitstream; and
filter, during the inference phase of the ML pipeline, the second irrelevant images from the second compressed bitstream prior to the second compressed bitstream being transmitted to the decompression stage of the ML pipeline.

9. The at least one computer readable storage medium of claim 8, wherein the instructions, when executed, further cause the computing system to bypass one or more decoding operations of the decompression stage with respect to the second irrelevant images.

10. The at least one computer readable storage medium of claim 8, wherein the instructions, when executed, further cause the computing system to bypass one or more pre-processing operations of the decompression stage with respect to the second irrelevant images.

11. The at least one computer readable storage medium of claim 8, wherein the instructions, when executed, further cause the computing system to transition the ML pipeline from the training phase to the inference phase in response to a detection that the training phase has reached a target level of accuracy.

12. The at least one computer readable storage medium of claim 8, wherein the second irrelevant images are filtered from the second compressed bitstream prior to the second compressed bitstream being transmitted to a network controller.

13. The at least one computer readable storage medium of claim 8, wherein the instructions, when executed, further cause the computing system to conduct an accuracy adjustment of the inference phase via a recall-precision operating point, wherein the accuracy adjustment bypasses a repeat of the training phase.

14. The at least one computer readable storage medium of claim 8, wherein the instructions, when executed, further cause the computing system to bypass a modification of an ML model in the ML pipeline.

15. A method comprising:
filtering, during a training phase of a machine learning (ML) pipeline, first irrelevant images from a first compressed bitstream based on reinforcement learning feedback from the ML pipeline, wherein the first irrelevant images are filtered from the first compressed bitstream prior to the first compressed bitstream being transmitted to a decompression stage of the ML pipeline;
identifying, during an inference phase of the ML pipeline, second irrelevant images in a second compressed bitstream; and
filtering, during the inference phase of the ML pipeline, the second irrelevant images from the second compressed bitstream prior to the second compressed bitstream being transmitted to the decompression stage of the ML pipeline.

16. The method of claim 15, further comprising:
bypassing one or more decoding operations of the decompression stage with respect to the second irrelevant images; and
bypassing one or more pre-processing operations of the decompression stage with respect to the second irrelevant images.

17. The method of claim 15, further including transitioning the ML pipeline from the training phase to the inference phase in response to a detection that the training phase has reached a target level of accuracy.

18. The method of claim 15, wherein the second irrelevant images are filtered from the second compressed bitstream prior to the second compressed bitstream being transmitted to a network controller.

19. The method of claim 15, further comprising conducting an accuracy adjustment of the inference phase via a recall-precision operating point, wherein the accuracy adjustment bypasses a repeat of the training phase.

20. The method of claim 15, further comprising bypassing a modification of an ML model in the ML pipeline.
